(19) United States
(12) Patent Application Publication
(10) Pub. No.: US 2013/0189097 A1
(43) Pub. Date: Jul. 25, 2013

(54) TURBOMACHINE INCLUDING A BLADE TUNING SYSTEM

(71) Applicants: Ryan Zane Ziegler, Simpsonville, SC (US); Spencer Aaron Kareff, Simpsonville, SC (US); Brian Denver Potter, Greer, SC (US)

(72) Inventors: Ryan Zane Ziegler, Simpsonville, SC (US); Spencer Aaron Kareff, Simpsonville, SC (US); Brian Denver Potter, Greer, SC (US)

(73) Assignee: GENERAL ELECTRIC COMPANY, Schenectady, NY (US)

(21) Appl. No.: 13/354,636

(22) Filed: Jan. 20, 2012

(51) Int. Cl. B64C 11/06

(52) U.S. Cl. 416/1; 416/147

(57) ABSTRACT

A turbomachine includes a compressor portion, a turbine portion operatively connected to the compressor portion, a combustor assembly fluidly connected to each of the compressor portion and the turbine portion, a blade element including a base portion, an airfoil portion, and a natural frequency generated during rotation of the blade element. The blade element is rotatably mounted within one of the compressor portion and the turbine portion, and a blade tuning member rotatably mounted in the one of the compressor portion and the turbine portion. The blade tuning member is configured for engagement with the blade element to alter the natural frequency.

### BACKGROUND OF THE INVENTION

The subject matter disclosed herein relates to the art of turbomachines and, more particularly, to a turbomachine including a blade tuning system.

Many turbomachines include a compressor portion linked to a turbine portion through a common compressor/turbine shaft or rotor and a combustor assembly. The compressor portion guides a compressed air flow through a number of sequential stages toward the combustor assembly. In the combustor assembly, the compressed air flow mixes with a fuel to form a combustible mixture. The combustible mixture is combusted in the combustor assembly to form hot gases. The hot gases are guided to the turbine portion through a transition piece. The hot gases expand through the turbine portion along a hot gas path and impart a force to a series of buckets or blades mounted to rotors that, in turn, are coupled to a shaft.

The force causes the blade to rotate creating work that is output through the shaft to, for example, power a generator, a pump, or to provide power to a vehicle. In addition to providing compressed air for combustion, a portion of the compressed airflow is passed through the turbine portion for cooling purposes. The hot gases flowing over the blades create a sound footprint. That is, the blades possess a natural frequency property that is triggered by the hot gas flow. Occasionally, the natural frequency of the blades may match combustor frequency tone ranges. In such cases, the turbomachine may vibrate excessively.

### BRIEF DESCRIPTION OF THE INVENTION

According to one aspect of the exemplary embodiment, a turbomachine includes a compressor portion, a turbine portion operatively connected to the compressor portion, a combustor assembly fluidly connected to each of the compressor portion and the turbine portion, a blade element including a base portion, an airfoil portion, and a natural frequency generated during rotation of the blade element. The blade element is rotatably mounted within one of the compressor portion and the turbine portion, and a blade tuning member rotatably mounted in the one of the compressor portion and the turbine portion. The blade tuning member is configured for engagement with the blade element to alter the natural frequency.

According to another aspect of the exemplary embodiment, a method for adjusting a natural frequency of a blade element in a turbomachine during operation includes rotating a blade element within the turbomachine, positioning a blade tuning member having a predetermined stiffness to contact the blade element, and adjusting a natural frequency of the blade element through contact between the blade element and the blade tuning member.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a turbomachine including a blade tuning system in accordance with an exemplary embodiment;

FIG. 2 is a partial cross-sectional view of a turbine portion of the turbomachine of FIG. 1;

FIG. 3 is a detail view of a blade tuning member having a blade tuning element contacting a blade tuning component formed on a blade of the turbine portion of FIG. 2;

FIG. 4 is a detail view of the blade tuning element of FIG. 3 contacting a blade tuning component in accordance with another aspect of the exemplary embodiment; and

FIG. 5 is a detail view of first and second blade tuning members contacting corresponding blade tuning components formed on an upstream side and a downstream side of the blade of FIG. 3.

The detailed description explains embodiments of the invention, together with advantages and features, by way of example with reference to the drawings.

### DETAILED DESCRIPTION OF THE INVENTION

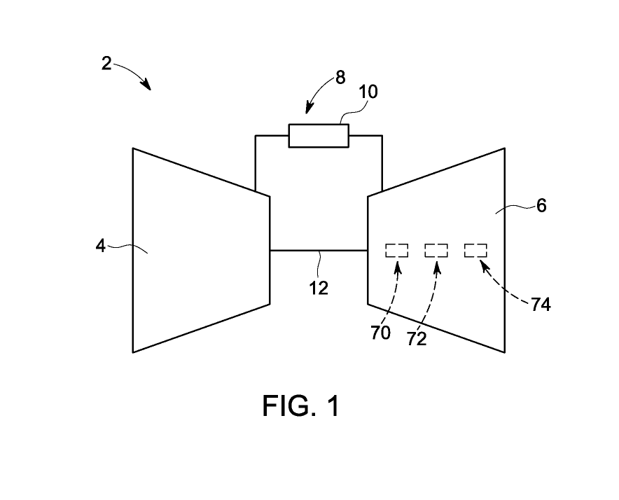

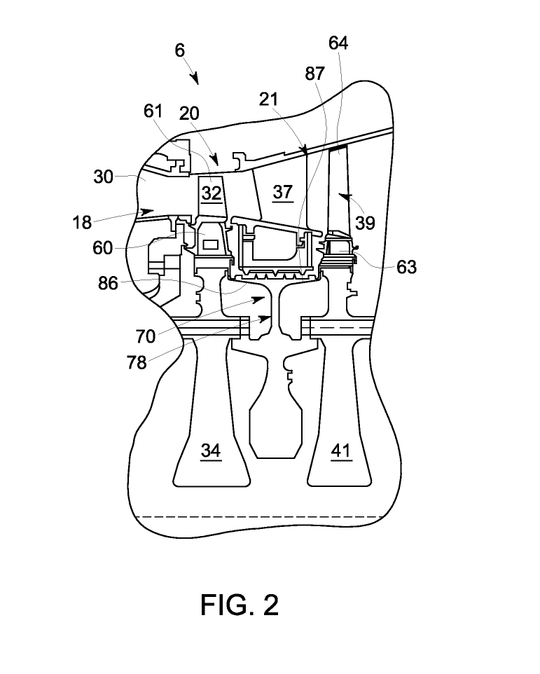

With reference to FIGS. 1 and 2, a turbomachine constructed in accordance with an exemplary embodiment is indicated generally at 2. Turbomachine 2 includes a compressor portion 4 operatively connected to a turbine portion 6. A combustor assembly 8 is fluidly connected to compressor portion 4 and turbine portion 6. Combustor assembly 8 is formed from a plurality of circumferentially spaced combustors, one of which is indicated at 10. Of course it should be understood that combustor assembly 8 could include other arrangements of combustors. Compressor portion 4 is also linked to turbine portion 6 through a common compressor/turbine shaft 12. With this arrangement, compressor portion 4 delivers compressed air to combustor assembly 8. The compressed air mixes with a combustible fluid or fuel to form a combustible mixture. The combustible mixture is combusted in combustor 10 to form products of combustion or hot gases that are delivered to turbine portion 6 through a transition piece (not shown). The hot gases expand through turbine portion 6 along a gas path 18 to power, for example, a generator, a pump, a vehicle or the like (also not shown).

In the exemplary embodiment shown, turbine portion 6 includes first and second stages 20 and 21 that define gas path 18. Of course it should be understood that the number of stages in turbine portion 6 could vary. First stage 20 includes a plurality of first stage stators or nozzles, one of which is indicated at 30, and a plurality of first stage buckets or blade elements, one of which is indicated at 32, mounted to a first stage rotor wheel 34. Second stage 21 includes a plurality of second stage stators or nozzles, one of which is indicated at 37, and a plurality of second stage buckets or blade elements, one of which is indicated at 39, mounted to a second stage rotor wheel 41. Blade elements 32 include a base portion 60 and an airfoil portion 61. Likewise, blade elements 39 include a base portion 63 and an airfoil portion 64. Blade elements 32 and 39 also include a natural frequency property that is associated with blade element geometry and blade element material.

In accordance with an exemplary embodiment, turbomachine 2 includes a blade tuning member 70 arranged between first and second turbine stages 20 and 21. As will become more fully evident below, blade tuning member 70 is configured to adjust the natural frequency of blade elements 32 and 39. In the exemplary embodiment shown, blade tuning member 70 takes the form of near flow path seal 78. However, it should be understood that blade tuning member 70 may be a separate structure provided in turbine portion 6. In the exemplary embodiment shown, blade tuning member 70 includes a first blade tuning element 86 and a second blade tuning element 87. First blade tuning element 86 is cantilevered from blade tuning member 70 and extends toward base portion 60 of blade elements 32. Second blade tuning element 87 is cantilevered from blade tuning member 70 and that extends toward base portion 63 of blade elements 39. At this point it should be understood that blade tuning member 72 and 74 include generally similar structure.

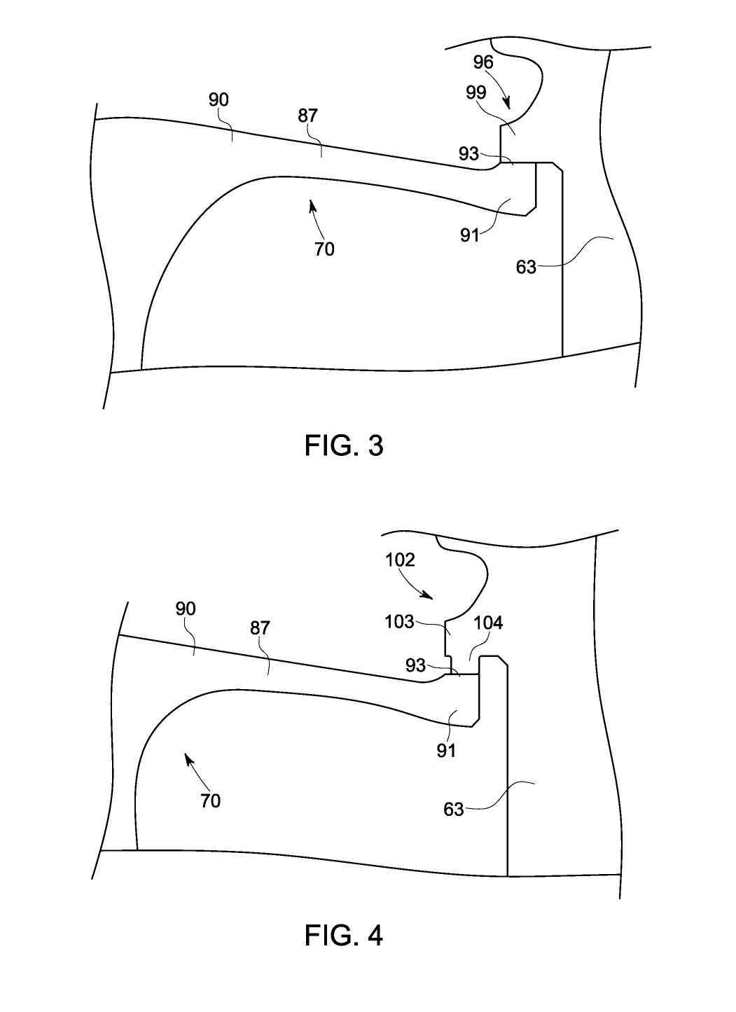

As best shown in FIG. 3, blade tuning element 87 includes a first end 90 that extends to a second end 91. Second end 91 includes a crown element 93 that contacts and exerts pressure upon base portion 63 of blade elements 39. More specifically, blade elements 39 include a blade tuning component 96 having a projection 99 that extends axially upstream from base portion 63. Blade tuning element 87 has a stiffness property that is selectively chosen to tune the natural frequency property of blade elements 39 to a predetermined value. With this arrangement, the natural frequency property of blade elements 39 can be adjusted to reduce vibratory response. At this point it should be understood that blade tuning element 86 acts upon base portions 60 of blade elements 32 in a similar manner. FIG. 4 illustrates a blade tuning component 102 having a projection 103 provided with a radially projecting appendage 104. Crown member 93 contacts and applies pressure to radially extending appendage 104 to alter the natural frequency property of blade element 39. The particular length of radially projecting appendage 104 may be varied to achieve a desired natural frequency property for blade elements 39.

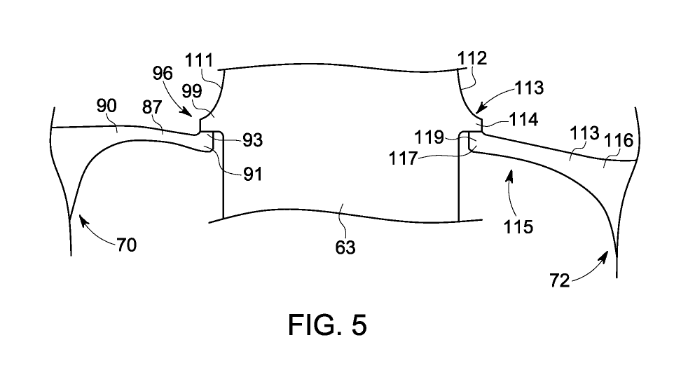

FIG. 5 illustrates an upstream side 111 and a downstream side 112 of base portion 63. Blade tuning component 96 is arranged on upstream side 111 and another blade tuning component 113 having a projection 114 is arranged on downstream side 112. Blade tuning element 87 acts upon blade tuning component 96 and blade tuning member 72 acts upon blade tuning component 113. More specifically blade tuning member 72 includes a blade tuning element 115 that acts upon blade tuning component 113. Blade tuning element 115 includes a first end 116 that extends from blade tuning member 72 to a second, cantilevered end 117. Second end 117 includes a crown element 119 that acts upon projection 114. With this arrangement, blade tuning member 70 acts upon base portion 63 to tune the natural frequency property of blade element 39.

At this point it should be understood that the exemplary embodiments describe a system for adjusting a natural frequency property of rotating turbomachine blade elements. Blade tuning members act upon base portions of the rotating blade element to alter blade element stiffness. In this manner, blade element stifthess can be adjusted to tune the natural frequency property of each blade element to a desired value. Stiffness can be adjusted by adding elements to the base portion of the buckets, increasing or decreasing a length of the blade tuning elements, altering a thickness of the blade tuning elements, adjusting a height of the crown elements, or altering a volume of the blade tuning elements, e.g., forming hollow regions in the blade tuning element. Selectively altering or tuning the natural frequency property of each blade element row will separate natural frequency property of one stage from a natural frequency of another stage to improve frequency margin requirements.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A turbomachine comprising:
a compressor portion;
a turbine portion operatively connected to the compressor portion;
a combustor assembly fluidly connected to each of the compressor portion and the turbine portion;
a blade element including a base portion, an airfoil portion, and a natural frequency generated during rotation of the blade element, the blade element being rotatably mounted within one of the compressor portion and the turbine portion; and
a blade tuning member rotatably mounted in the one of the compressor portion and the turbine portion, the blade tuning member configured for engagement with the blade element to alter the natural frequency.

2. The turbomachine according to claim 1, wherein the blade tuning member includes a blade tuning element configured for engagement with the blade element to alter the natural frequency.

3. The turbomachine according to claim 2, wherein the blade tuning element is cantilevered from the blade tuning member.

4. The turbomachine according to claim 2, wherein the blade element includes blade tuning component configured for engagement with the blade tuning element.

5. The turbomachine according to claim 4, wherein the blade tuning component is provided on the base portion of the blade element.

6. The turbomachine according to claim 5, wherein the blade tuning component comprises a projection that projects axially outward from the base portion.

7. The turbomachine according to claim 6, wherein the blade tuning component includes a radially projecting appendage.

8. The turbomachine according to claim 2, wherein the blade tuning element includes a crown element configured for engaging the blade element.

9. The turbomachine according to claim 1, wherein the blade tuning member comprises a near flow path seal of the turbine portion.

10. The turbomachine according to claim 1, wherein the turbomachine includes a first blade tuning member arranged upstream of the blade element and a second blade tuning member arranged downstream of the blade element.

11. The turbomachine according to claim 10, wherein the first blade tuning member includes a first blade tuning element and the second blade tuning member includes a second blade tuning element.

12. The turbomachine according to claim 11, wherein the blade element includes an upstream side and a downstream side, the upstream side including a first blade tuning component configured for engagement with the first blade tuning element, and the downstream side including a second blade tuning component configured for engagement with the second blade tuning element.

13. A method for adjusting a natural frequency of a blade element in a turbomachine during operation, the method comprising:
rotating a blade element within the turbomachine;
positioning a blade tuning member having a set stiffness to contact the blade element; and
adjusting a natural frequency of the blade element through contact between the blade element and the blade tuning member.

14. The method of claim 13, further comprising: applying a pressure to the blade element through the blade tuning member.

15. The method of claim 13, further comprising: selectively adjusting a stiffness of the blade tuning member to obtain a desired natural frequency of the blade element.

16. The method of claim 15, wherein selectively adjusting a stiffness of the blade element includes contacting the blade element with a blade tuning element having a varying thickness cantilevered from the blade tuning member.

17. The method of claim 15, wherein selectively adjusting a stiffness of the blade element includes contacting the blade element with a blade tuning element having a hollow portion cantilevered from the blade tuning member.

18. The method of claim 15, wherein selectively adjusting a stiffness of the blade element includes contacting the blade element with a crown element projecting generally radially outward from the blade tuning member.

19. The method claim 15, selectively adjusting a stiffness of the blade element includes contacting a blade tuning component provided on the blade element with the blade tuning member.

20. The method of claim 13, wherein positioning the blade tuning member includes arranging a first blade element tuning member upstream of the blade element and a second blade element tuning member downstream of the blade element.
